(19) United States
(12) Patent Application Publication
(10) Pub. No.: US 2023/0072837 A1
(43) Pub. Date: Mar. 9, 2023

(54) APPLICATION BANDWIDTH THROTTLING

(71) Applicant: CyberReef, Inc., Shreveport, LA (US)

(72) Inventors: Jamie Brown, Shreveport, LA (US); Hilton Nicholson, Bossier City, LA (US); Christopher Nelson, Clifton Park, NY (US); Chitti Lakshmi Deepak Doddigarla, Ruston, LA (US); Sivapoornima Karuturi, Ruston, LA (US); Alexander Lott, Bossier City, LA (US); Christopher Landman, Bossier City, LA (US); Michael Edgar, Bossier City, LA (US); Nishyant Jani, Shreveport, LA (US); Stacey Stewart-Sweat, Gloster, LA (US); John Stewart-Sweat, Gloster, LA (US)

(73) Assignee: CyberReef, Inc., Shreveport, LA (US)

(21) Appl. No.: 17/885,666

(22) Filed: Aug. 11, 2022

Related U.S. Application Data
(60) Provisional application No. 63/278,282, filed on Nov. 11, 2021.
(60) Provisional application No. 63/236,466, filed on Aug. 24, 2021.

(51) Int. Cl. H04L 47/80; H04L 47/22; H04L 47/24; H04L 47/32

(52) U.S. Cl. CPC H04L 47/803; H04L 47/22; H04L 47/24; H04L 47/32

(57) ABSTRACT

A method for processing network data, comprising receiving a data packet at a first processor having a non-transient data memory, storing the data packet in the non-transient data memory, accessing one or more first data fields of the data packet in the data memory, determining whether a device is bandwidth limited as a function of the first data fields being associated with an application, transmitting the data packet to a second processor over a network if it is determined that the device is not bandwidth limited, determining whether the device has reached a limit if it is determined that the device is bandwidth limited, transmitting the data packet to the second processor over the network if it is determined that the limit has not been reached and deleting the data packet without transmitting the data packet if it is determined that the limit has been reached.

### RELATED APPLICATIONS

This application claims priority to and benefit of U.S. Provisional patent application 63/278,282, filed Nov. 11, 2021, and U.S. Provisional patent application 63/236,466, filed Aug. 24, 2021, each of which is hereby incorporated by reference for all purposes as if set forth herein in its entirety.

### TECHNICAL FIELD

The present disclosure relates generally to network bandwidth management, and more specifically to network bandwidth management that provides flexible control of bandwidth to specific applications and users.

### BACKGROUND OF THE INVENTION

Control of bandwidth usage is typically indiscriminate as to which applications are bandwidth limited, such that a device that is subject to bandwidth restrictions will not be able to exceed those restrictions for specific applications.

### SUMMARY OF THE INVENTION

A method for processing network data is disclosed that includes receiving a data packet at a first processor having a non-transient data memory. The data packet is stored in the non-transient data memory, and one or more first data fields of the data packet are accessed in the data memory. It is determined whether a device is bandwidth limited as a function of the first data fields being associated with an application, and the data packet is transmitted to a second processor over a network if it is determined that the device is not bandwidth limited. It is determined whether the device has reached a limit if it is determined that the device is bandwidth limited, and the data packet is transmitted to the second processor over the network if it is determined that the limit has not been reached. The data packet is deleted without transmitting the data packet if it is determined that the limit has been reached.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for bandwidth management, in accordance with an example embodiment of the present disclosure;

FIG. 2 is a diagram of a system for controlling application bandwidth usage, in accordance with an example embodiment of the present disclosure;

FIG. 3 is a diagram of an algorithm for bandwidth management, in accordance with an example embodiment of the present disclosure;

FIG. 4 is a diagram of a system for bandwidth management, in accordance with an example embodiment of the present disclosure;

FIG. 5 is a diagram of an algorithm for processing a data packet, in accordance with an example embodiment of the present disclosure;

FIG. 6 is a diagram of a system for bandwidth management, in accordance with an example embodiment of the present disclosure;

FIG. 7 is a diagram of a system providing a cloud services architecture, in accordance with an example embodiment of the present disclosure;

FIG. 8 is a diagram of a system for application throttling, in accordance with an example embodiment of the present disclosure; and

FIG. 9 is a diagram of a system for bandwidth management, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

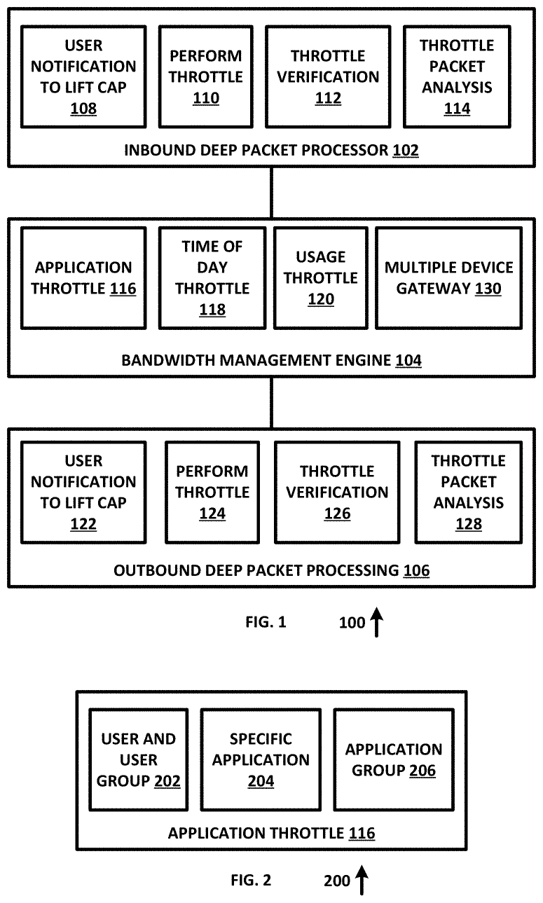

FIG. 1 is a diagram of a system 100 for bandwidth management, in accordance with an example embodiment of the present disclosure. System 100 includes inbound deep packet processor 102, bandwidth management engine 104, outbound deep packet processing 106, user notification to lift cap 108, perform throttle 110, throttle verification 112, throttle packet analysis 114, application throttle 116, time of day throttle 118, usage throttle 120, user notification to lift cap 122, perform throttle 124, throttle verification 126, throttle packet analysis 128 and multiple device gateway 130, each of which can be implemented in hardware or a suitable combination of hardware and software.

Inbound deep packet processor 102 can be implemented as one or more algorithms operating on a processor that causes the processor to receive network data packets and processes the network data packets by accessing predetermined data fields within each packet. In one example embodiment, inbound deep packet processor 102 can receive a data packet that includes overhead data and payload data, can identify the format of the packet from the overhead data, can identify the format of the payload, can identify one or more embedded data fields and can perform other suitable processes.

Bandwidth management engine 104 can be implemented as one or more algorithms operating on a processor that causes the processor to implement one or more bandwidth management processes as a function of data identified by inbound deep packet processor 102 or outbound deep packet processor 106, such as to prevent data from being transmitted to or requested by a client processor, by modifying the bandwidth of the data provided by an application or in other suitable manners. In one example embodiment, bandwidth management engine 104 can block requests sent from a client to an external server, can modify the bandwidth setting of an associated application reduce a data rate or can perform other suitable processes.

Outbound deep packet processing 106 can be implemented as one or more algorithms operating on a processor that causes the processor to receive network data packets and processes the network data packets by accessing predetermined data fields within each packet. While deep packet inspection can be performed for inbound packets, in one alternative example embodiment, outbound deep packet processor 106 can also or alternatively be used to receive a data packet that includes overhead data and payload data, can identify the format of the packet from the overhead data, can identify the format of the payload, can identify one or more embedded data fields and can perform other suitable processes.

User notification to lift cap 108 can be implemented as one or more algorithms operating on a processor that causes the processor to generate a user control to allow a user to lift a data rate or total data limit or to perform other suitable functions. In one example embodiment, a user can be notified that they are approaching a data limit and can be provided with a functional control that allows them to request a modification of the data limit, such as by identifying an authorization code, by paying additional fees or in other suitable manners.

Perform throttle 110 can be implemented as one or more algorithms operating on a processor that causes the processor to reduce a total data consumption, a data bandwidth consumption or other data consumed by a user. In one example embodiment, perform throttle 110 can modify a setting of an application, or can also or alternatively send a control message to the application server to cause it to change a type of data being provided, such as to change from high definition video to standard definition video. In another example embodiment, perform throttle 110 can block data request packets to the application to prevent the application from responding, can block data packets that are addressed to a client from an application to prevent the client from receiving and responding to the application, can buffer the data packets and store or drop them and can perform other suitable functions.

Throttle verification 112 can be implemented as one or more algorithms operating on a processor that causes the processor to verify that data provided by or used by an application has been appropriately reduced. In one example embodiment, throttle verification 112 can generate data statistics for an application, a client or other suitable processes, such as to ensure that the client is not using more than an allocated amount of data or data bandwidth. Likewise, throttle verification 112 can generate one or more queries and process one or more responses to determine whether a selected data usage statistic has been met.

Throttle packet analysis 114 can be implemented as one or more algorithms operating on a processor that causes the processor to read packet header and payload data and to analyze one or more data fields to determine a type of packet, a size and type of payload, an associated application, an IP address or other suitable data. In one example embodiment, throttle packet analysis 114 can be used to mark packets for throttling, to verify that marked packets are properly handled or to perform other suitable functions.

Application throttle 116 can be implemented as one or more algorithms operating on a processor that causes the processor to reduce bandwidth or data usage for an associated application. In one example embodiment, application throttle 116 can store usage data that defines an allowable bandwidth, an allowable data rate or other suitable data, such as for an application, a device, a user or other suitable controls. Application throttle 116 can allocate bandwidth or data as a function of available bandwidth, such as to allow a user with a lower bandwidth or data to receive more data than they are allocated if there is data or bandwidth available, or can perform other suitable functions.

Time of day throttle 118 can be implemented as one or more algorithms operating on a processor that causes the processor to reduce bandwidth or data usage for an associated time period. In one example embodiment, time of day throttle 118 can store usage data that defines an allowable bandwidth, an allowable data rate or other suitable data, such as for a predetermined time period or a running average for a user, an enterprise, an application or other suitable controls. Time of day throttle 118 can allocate bandwidth or data as a function of a time period, such as to allow a user with a lower bandwidth or data to receive more data than they are allocated at predetermined times, can also or alternatively determine if the total available bandwidth or data is below a predetermined level for a period or if there is data or bandwidth available, or can perform other suitable functions.

Usage throttle 120 can be implemented as one or more algorithms operating on a processor that causes the processor to reduce bandwidth or data usage for an associated usage. In one example embodiment, usage throttle 120 can store usage data that defines an allowable bandwidth, an allowable data rate or other suitable data, such as for a predetermined channel or a running average for a user, an enterprise, an application or other suitable controls. Usage throttle 120 can allocate bandwidth or data as a function of a data channel, such as to allow a user with a lower bandwidth or data to receive more data than they are allocated at predetermined times, if the total available bandwidth or data is below a predetermined level for a channel or if there is data or bandwidth available, or can perform other suitable functions.

User notification to lift cap 122 can be implemented as one or more algorithms operating on a processor that causes the processor to generate a user control to allow a user to lift a data rate or total data limit or to perform other suitable functions. In one example embodiment, a user can be notified that they are approaching a data limit and can be provided with a functional control that allows them to request a modification of the data limit, such as by identifying an authorization code, by paying additional fees or in other suitable manners.

Perform throttle 124 can be implemented as one or more algorithms operating on a processor that causes the processor to reduce a total data consumption, a data bandwidth consumption or other data consumed by a user. In one example embodiment, perform throttle 124 can modify a setting of an application, or can also or alternatively send a control message to the application server to cause it to change a type of data being provided, such as to change from high definition video to standard definition video. In another example embodiment, perform throttle 124 can block data request packets to the application to prevent the application from responding, can block data packets that are addressed to a client from an application to prevent the client from receiving and responding to the application, can buffer the data packets and store or drop them and can perform other suitable functions.

Throttle verification 126 can be implemented as one or more algorithms operating on a processor that causes the processor to verify that data provided by or used by an application has been appropriately reduced. In one example embodiment, throttle verification 126 can generate data statistics for an application, a client or other suitable processes, such as to ensure that the client is not using more than an allocated amount of data or data bandwidth. Likewise, throttle verification 126 can generate one or more queries and process one or more responses to determine whether a selected data usage statistic has been met.

Throttle packet analysis 128 can be implemented as one or more algorithms operating on a processor that causes the processor to read packet header and payload data and to analyze one or more data fields to determine a type of packet, a size and type of payload, an associated application, an IP address or other suitable data. In one example embodiment, throttle packet analysis 128 can be used to mark packets for throttling, to verify that marked packets are properly handled or to perform other suitable functions.

Multiple device gateway 130 can be implemented as one or more algorithms operating on a processor that causes the processor to determine whether the source IP address, destination IP address, the application data, the source port, the destination port, the packet sequence numbers or other data in the packet header indicates that two or more separate endpoint devices are accessing the network through a single gateway device. In one example embodiment, bandwidth management engine 104 can identify a gateway device that is receiving data packets and can perform additional packet header data processing to identify two or more distinct end point devices that are accessing the network and consuming network bandwidth, so as to restrict network usage for each device as a function of its associated user.

FIG. 2 is a diagram of a system 200 for controlling application bandwidth usage, in accordance with an example embodiment of the present disclosure. System 200 includes application throttle 116 and user and user group 202, specific application 204 and application group 206, each of which can be implemented in hardware or a suitable combination of hardware and software.

User and user group 202 can be implemented as one or more algorithms operating on a processor that causes the processor to identify a user or group associated with a user that has predetermined data usage controls. In one example embodiment, a user or user group such as administrators can be provided with higher bandwidth consumption levels then other users or user groups, where a user's data bandwidth or total data usage settings are based on the user's role or a group that a user is associated with. In this example embodiment, bandwidth and total data usage limits can be selected as a function of user roles or user groups, such as to increase usage for one user or group of users by reducing usage for a different user or group of users or in other suitable embodiments.

Specific application 204 can be implemented as one or more algorithms operating on a processor that causes the processor to identify an application that has predetermined data usage controls. In one example embodiment, an application such as a streaming content provider service can be provided with higher bandwidth consumption levels then other applications, where an application's data bandwidth or total data usage settings are based on an application that a user is associated with. In this example embodiment, bandwidth and total data usage limits can be selected as a function of an application, such as to increase usage for one application by reducing usage for a different application or group of applications or in other suitable embodiments.

Application group 206 can be implemented as one or more algorithms operating on a processor that causes the processor to identify a group of applications that have predetermined data usage controls. In one example embodiment, applications used for network control can be provided with higher bandwidth consumption levels than other applications, where the data bandwidth or total data usage settings are based on the group of applications. In this example embodiment, bandwidth and total data usage limits can be selected as a function of applications, such as to increase usage for a group of applications by reducing usage for a different application or group of applications or in other suitable embodiments.

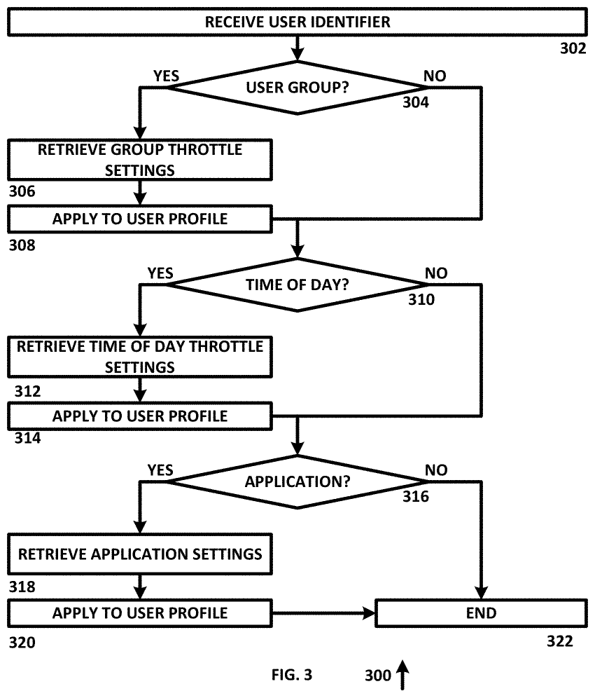

FIG. 3 is a diagram of an algorithm 300 for bandwidth management, in accordance with an example embodiment of the present disclosure. Algorithm 300 can be implemented in hardware or a suitable combination of hardware and software.

Algorithm 300 begins at 302, where a user identifier is received. In one example embodiment, the user identifier can be associated with a client application, a device, a user profile or other suitable data. The algorithm then proceeds to 304.

At 304, it is determined whether the user is a member of a user group. In one example embodiment, each user can have one or more group identifiers that allow permissions for the user to be assigned as a function of the group or groups that the user is a member of. If it is determined that the user is a member of a user group, the algorithm proceeds to 306, otherwise the algorithm proceeds to 310.

At 306, group throttle settings are retrieved. In one example embodiment, group throttle settings can be allocated for specific enterprise functions, such as to prevent certain employee groups from accessing predetermined applications or exceeding predetermined data usage rates during certain hours. The algorithm then proceeds to 308.

At 308, the group throttle settings are applied to a user profile. In one example embodiment, the user's profile can include a white list of allowed applications and associated data rates, a black list of prohibited applications or other suitable throttle settings. The algorithm then proceeds to 310.

At 310, it is determined whether time of day settings apply to the user. In one example embodiment, a time of day profile can be stored for a user, a group of users, specific applications or other suitable logical entities, and the determination can be made by accessing the profile and setting one or more data flags associated with time of day settings or in other suitable manners. If it is determined that time of day settings apply, the algorithm proceeds to 312, otherwise the algorithm proceeds to 316.

At 312, time of day throttle settings are retrieved. In one example embodiment, the throttle settings can be retrieved from a data storage device or in other suitable manners. The algorithm then proceeds to 314.

At 314, the time of day throttle settings are applied to the user profile. In one example embodiment, the user profile can be implemented by a bandwidth manager that performs a deep packet inspection process where a user is identified by an IP address, a user identifier or other suitable data, and throttle settings are applied by dropping or passing each packet, by changing device or application settings or in other manners. The algorithm then proceeds to 316.

At 316, it is determined whether application settings should be applied. In one example embodiment, an application profile can be stored for a user, a group of users, specific applications or other suitable logical entities, and the determination can be made by accessing the profile and setting one or more data flags associated with application settings or in other suitable manners. If it is determined that application settings should be applied, the algorithm proceeds to 318, otherwise the algorithm proceeds to 322.

At 318, application settings are retrieved. In one example embodiment, the application settings can be retrieved from a data storage device or in other suitable manners. The algorithm then proceeds to 320.

At 320, the application settings are applied to the user profile. In one example embodiment, the user profile can be implemented by a bandwidth manager that performs a deep packet inspection process where a user is identified by an IP address, a user identifier or other suitable data, and throttle settings are applied by dropping or passing each packet, by changing device or application settings or in other manners. The algorithm then proceeds to 322 and terminates.

In operation, algorithm 300 provides for bandwidth management. While algorithm 300 is shown as a flow chart, it can also or alternatively be implemented as a state diagram, a ladder diagram, using object oriented programming or in other suitable manners.

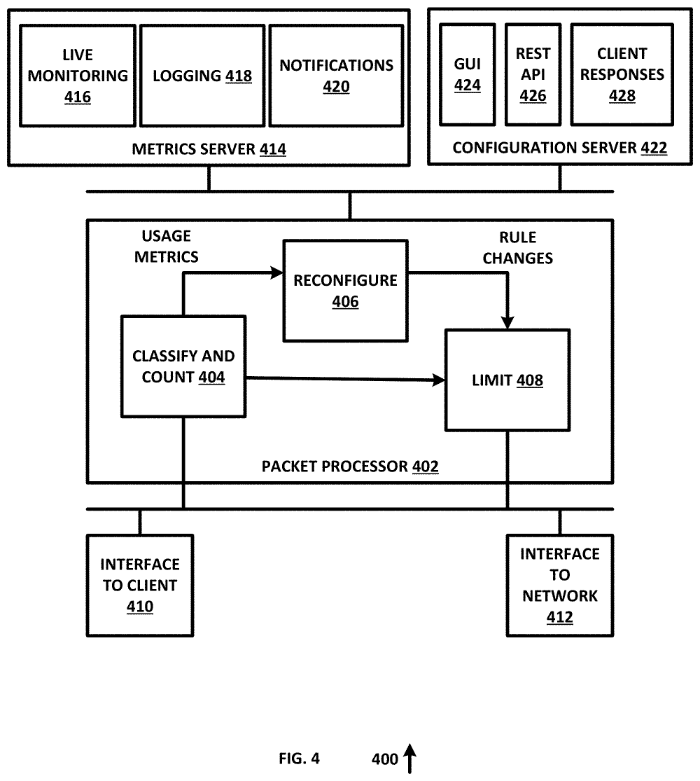

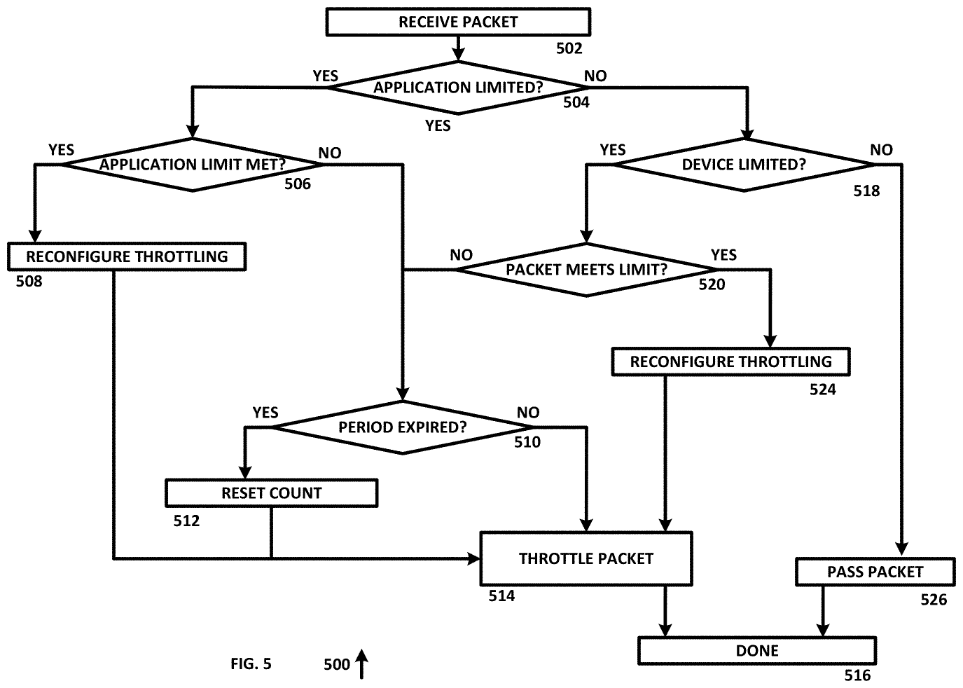

FIG. 4 is a diagram of a system 400 for bandwidth management, in accordance with an example embodiment of the present disclosure. System 400 includes packet processor 402, classify and count 404, reconfigure 406, limit 408, interface to client 410, interface to network 412, metrics server 414, live monitoring 416, reconfigure 418, notifications 420, configuration server 422, graphic user interface 424, REST API 426 and client responses 428, each of which can be implemented in hardware or a suitable combination of hardware and software.

Packet processor 402 can be implemented as one or more algorithms operating on a processor that causes the processor to perform deep packet inspection or processing. In one example embodiment, packet processor 402 can include packet buffers, analysis algorithms and other suitable components to support packet processing by identify one or more bits in the packet and associating those bits with predetermined data fields.

Classify and count 404 can be implemented as one or more algorithms operating on a processor that causes the processor to perform classification and counting processes associated with packets and bandwidth restrictions. In one example embodiment, each packet can be classified based on one or more settings, such as based on a logical entity such as a user group, an IP address, an application and other suitable classification data. The payload bit size of each packet, total bit size of each packet or other suitable data can be counted for the associated logical entities, to allow a total number of bits of data used by that logical entity to be determined.

Reconfigure 406 can be implemented as one or more algorithms operating on a processor that causes the processor to receive usage metrics data and to select one or more rule changes as a function of the user metrics. In one example embodiment, a usage metric can be received that requires a rule change to reduce a bandwidth or data usage allocated for a user, such as if the user has exceeded an allowable bandwidth or data usage, if the available bandwidth or data usage for an enterprise is nearing a limit and the user is in an employee group with lower priority, or in other suitable manners.

Limit 408 can be implemented as one or more algorithms operating on a processor that causes the processor to implement one or more bandwidth limits, data usage limits or other suitable limits. In one example embodiment, limit 408 can store data in a data packet that identifies packets that can be dropped, can generate control data to transmit to an application to change a data type or can perform other suitable processes.

Interface to client 410 can be implemented as one or more algorithms operating on a processor that causes the processor to receive data packets from a client and to provide data packets to a client. In one example embodiment, the way in which a packet is processed can be a function of whether the packet is being received from a client or transmitted to a client.

Interface to network 412 can be implemented as one or more algorithms operating on a processor that causes the processor to receive data packets from an external application over a network and to provide data packets to an external application over a network. In one example embodiment, the way in which a packet is processed can be a function of whether the packet is being received from an external application over a network or transmitted to an external application over a network.

Metrics server 414 can be implemented as one or more algorithms operating on a processor that causes the processor to perform metrics-related data processing. In one example embodiment, one or more servers can be used to process metrics, such as where load balancing or other suitable processes are used.

Live monitoring 416 can be implemented as one or more algorithms operating on a processor that causes the processor to generate real-time data monitoring, such as to control bandwidth usage by one or more users of an enterprise. In one example embodiment, live monitoring 416 can be used to generate real-time user interface data to allow an operator to determine individual or overall data bandwidth usage, data usage or other suitable live monitoring data for a user, group of users, application, enterprise or other suitable logical entities.

Logging 418 can be implemented as one or more algorithms operating on a processor that causes the processor to log metrics that are processed. In one example embodiment, logging 418 can modify a period of time that is being monitored for data usage, a user group, an application or other suitable logical entities, and can store data associated with data usage, bandwidth or other suitable usage parameters for each logical entity.

Notifications 420 can be implemented as one or more algorithms operating on a processor that causes the processor to generate notification data for one or more users. In one example embodiment, notifications 420 can generate a user notification of a limit that has been reached for a specific application, that a user has reached a limit for a set of applications (such as using application group 206 or in other suitable manners), that a user has reached a limit for all usage (such as using user group 202 or in other suitable manners), when one or more users or a group has reached either of those limits, can allow a user to request additional bandwidth and can perform other suitable functions.

Configuration server 422 can be implemented as one or more algorithms operating on a processor that causes the processor to store one or more data configuration settings for a user, an application, a user group or other suitable logical entities. In one example embodiment, configuration server 422 can be used by an operator to modify configuration settings for a user, such as to increase a bandwidth or data usage for a user in response to a request from the user, to re-allocate data or bandwidth from one user, group of users or applications to other user, groups of users or applications, or to implement other suitable configurations.

Graphic user interface 424 can be implemented as one or more algorithms operating on a processor that causes the processor to generate a user interface with one or more controls for displaying and controlling metrics, such as to allow an operator to select an individual, to select a period of time or other suitable functions. In one example embodiment, graphic user interface 424 allows a user to select one or more algorithmic rules for controlling settings for an individual user, an individual device, a group of individuals or devices, an individual application, a group of applications or other suitable parameters, such as to reduce or increase bandwidth or data usage allocations totals, as a time of day, or other suitable settings.

REST API 426 can be implemented as one or more algorithms operating on a processor that causes the processor to support a representational state transfer API. In one example embodiment, REST API 426 can implement a representational state architecture applications programming interface for network applications or for other suitable purposes.

Client responses 428 can be implemented as one or more algorithms operating on a processor that causes the processor to process client responses. In one example embodiment, the client responses can be tracked using threads, REST programming paradigms or in other suitable manners.

In operation, system 400 can be used to provide a number of important technical features. In one example embodiment, system 400 can be used to provide an intelligent network filter that monitors traffic from devices by IP address and uses deep packet inspection to identify applications. System 400 can throttle or block traffic for specified combinations of address and application, can dynamically and automatically adjust throttling based on usage totals, can notify users of changes, can accept user requests to override throttling rules and perform other suitable functions as discussed further herein.

In one example embodiment, system 400 can classify and count data packets and inspect all data packets received at interface to client 410 or interface to network 412. The packets can be marked for further handling, and a number of bytes can be counted based on each of a plurality of different rules, as discussed further herein. The classification and counting output can be used to limit a data rate of a logical or physical channel based on the marks, and system 400 can reconfigure limits based on usage metrics, such as to increase limits if bandwidth is available, to decrease limits if bandwidth is not available, to modify limits in response to user controls or for other suitable purposes.

In another example embodiment, classifying and counting can include tracking traffic in response to a rule by identifying a client IP address, content (e.g., application like Netflix or GMail), or other suitable data, using deep packet inspection or other suitable processes. Packets can be marked for further processing, such as in a limit process or other suitable processes. A total number of bytes of payload that matches a rule can be determined and tracked for a suitable period, such as an hour, day, week, month, or billing cycle. Blocked packets can be buffered, dropped, compressed and stored or processed in other suitable manners.

In another example embodiment, queues can use packet marks to select a packet for an output queue, such as where the queue determines the data transmission rate, such as in the manner shown in the following table or in other suitable manners.

| Mark Number | IP Address | Applications | Limit |
|---|---|---|---|
| Mark 1 | 1.1.1.1 | Netflix | 5 Mbps |
| Mark 2 | 1.1.1.1 | YouTube | 5 Mbps |
| Mark 3 | 1.1.1.2 | All | 4 Mbps |
| Mark 4 | 1.1.1.3 | Spotify | 4 Mbps |

A reconfigure system can monitor usage, rules, and time and change limit configuration when appropriate. It can reduce data transmission limits or other suitable controls when a threshold is exceeded, can increase transmission limits or other suitable controls when a period expires and can perform other suitable functions.

Metrics can be provided to local and remote processes, such as to provide a graphic user interface that provides live monitoring from any browser, logging to store historical values, notifications to clients when events occur in the system via email or SMS or in other suitable manners. Usage limits can be stored in a configuration database that can be updated using the direct GUI for the server, a REST API that allows a portal and other software to integrate with the system, when clients respond to notifications to request changes by replying to SMS or selecting a link control in an email or in other suitable manners.

Notifications can be provided to users when their device crosses a specified threshold. For example, if the device is allowed 2 MB/day, a notification can be provided when the daily usage exceeds 2 MB/day. Usage patterns can also be analyzed and estimated future usage can be based on usage patterns, to allow a notification to be provided of an anticipated over-limit use. Users can respond to the SMS messages, email notification or in other suitable manners, such as to request or purchase more data.

A single server can be configured to support multiple service providers. Notifications can be configured to appear to come from different sources based on the client's service provider, and responses to notifications can be directed to the appropriate service provider.

FIG. 5 is a diagram of an algorithm for processing a data packet, in accordance with an example embodiment of the present disclosure.

Algorithm 500 begins at 502, where a data packet is received. In one example embodiment, the data packet can be received over a network using a predetermined network data packet format having a header with predetermined field format, a payload with a predetermined field format and other suitable characteristics. The algorithm then proceeds to 504.

At 504, it is determined whether an application associated with the data packet is limited, either individually or because the device's user is a member of a group. In one example embodiment, classify and count 404 or other suitable systems or devices can perform this process. If it is determined that the application associated with the data packet is not limited, the algorithm proceeds to 518, otherwise the algorithm proceeds to 506.

At 506, it is determined whether the data packet is associated with the limited application meets the application usage limit. In one example embodiment, classify and count 404 or other suitable systems or devices can perform this process. If it is determined that the data packet associated with the limited application meets the usage limit, the algorithm proceeds to 508, otherwise the algorithm proceeds to 510.

At 508, throttling is reconfigured in response to the determination that the application usage limit has been met. In one example embodiment, throttling can be reconfigured in response to one or more user requests, such as by using an operator interface that allows an operator to modify throttling for individual users, groups of users, individual applications, groups of applications or in other suitable manners. In another example embodiment, an operator can review real-time data through a graphic user interface and can dynamically modify throttling based on usage or non-usage of users, groups of users, applications, groups of application or other suitable logical entities. In addition, reconfigure 406 or other suitable systems or devices can perform this process. The algorithm then proceeds to 514.

At 510, it is determined whether a limit period has expired. In one example embodiment, classify and count 404 or other suitable systems or devices can perform this process. If it is determined that the limit period has not expired, the algorithm proceeds to 514, otherwise the algorithm proceeds to 512.

At 512, the count is reset. In one example embodiment, reconfigure 406 or other suitable systems or devices can perform this process. The algorithm then proceeds to 514.

At 514, the packet is throttled. In one example embodiment, packet throttling can be implemented by caching data packets, dropping data packets, modifying data packets, modifying application settings or in other suitable manners. Limit 408 or other suitable systems or devices can perform this process. The algorithm then proceeds to 516 and terminates.

At 518, it is determined whether all data is limited for the device that received the packet. In one example embodiment, classify and count 404 or other suitable systems or devices can perform this process. If it is determined that all data is limited for the device, the algorithm proceeds to 520, otherwise the algorithm proceeds to 526.

At 520, it is determined whether the packet meets the device limit. In one example embodiment, classify and count 404 or other suitable systems or devices can perform this process. If it is determined that the packet meets the device limit, the algorithm proceeds to 524, otherwise the algorithm proceeds to 510.

At 524, throttling is reconfigured in response to the determination that the application usage limit has been met. In one example embodiment, throttling can be reconfigured in response to one or more user requests, such as by using an operator interface that allows an operator to modify throttling for individual users, groups of users, individual applications, groups of applications or in other suitable manners. In another example embodiment, an operator can review real-time data through a graphic user interface and can dynamically modify throttling based on usage or non-usage of users, groups of users, applications, groups of application or other suitable logical entities. In addition, reconfigure 406 or other suitable systems or devices can perform this process. The algorithm then proceeds to 514.

At 526, the packet is passed without modification. In one example embodiment, a packet can be transmitted directly to a device from a packet cache, can be transmitted through one or more additional system or other suitable processes can also or alternatively be used. Limit 408 or other suitable systems or devices can perform this process. The algorithm then proceeds to 516.

In operation, algorithm 500 provides for processing a data packet. While algorithm 500 is shown as a flow chart, it can also or alternatively be implemented as a state diagram, a ladder diagram, using object oriented programming or in other suitable manners.

As discussed and disclosed herein, application throttling can be used to address problems, such as in cellular systems, to provide control to both customers and carriers. One problem that can be solved is network congestion problems, which can be solved by grooming(slowing down) the data session for a specific application that has been selected by the customer or carrier depending on service being provided. Another problem is carriers and data usage problems for customers. Other issues that application throttling can assist both customers and carriers with are:

1) data overages or general data usage—for example, customers may pay for HD or 4K video when running video heavy applications, and the present disclosure can allow customers to decide if they want to make system-wide or device-specific changes, such as reducing 4K or high definition (HD) video down to standard definition (SD) video. This function can allow a network traffic usage reduction of ˜68% from HD down to SD and higher for 4K.

2) cell site loading—overloading of a cell site with video data can place a major toll on the RF utilization at the cell site or overall carrier RF plan. Overloading impacts back haul costs as well. By reducing from HD/4K to SD, customer data bandwidth associated with video applications may be reduced up to 68% and more.

Application throttling can be provided a component of control features, starting with usage-based throttling and then extending that to application-specific throttling to allow a more granular handling of customer data. The disclosed functionality can be provided over a private network (such as a single tunnel or aggregated tunnel).

The present disclosure provides a number of functional attributes, including data security, secure private networking, malware threat protection, security filtering, zero trust transient data centers, data visibility, a portal for data insight, usage alerting, usage reporting, data analytics, data control, website filtering with usage throttling, application throttling, increased productivity, ensuring regulatory compliance and other functional attributes. The disclosed bandwidth manager can be used for multi-customer operations to provide true multi-tenancy, to make changes to prevent multi-day efforts for simple tasks, to improve reporting and for other purposes. The present disclosure allows a large number of applications to be throttled to a predetermined speed to reduce data usage and for applications to be added for customer selection upon customer request.

Bandwidth usage decisions can be made at the application level, for a category of applications, as well as usage-based alerting (trigger points) that can allow a user to receive unregulated speeds until a specific amount of data is used then triggering application throttling policies for that users or the entire group of users within that policy control group. An enterprise can have predetermined defined user groups that allow flexible policy management across the enterprise. Initial dependency are the systems that establish the private network and the services that run on the data session transacting through it.

When a network enterprise elects to put throttling in place as part of an initial private network setup around policy, the present disclosure can be used to perform the throttling at the application level, the application category level or based on other suitable parameters. Application throttling can be selected for throttling at all times, throttling based on usage alerts, throttling based on time of day or other suitable parameters. The throttling function can be implemented by carriers, customers or other suitable entities. In one example embodiment, customers will be able to view video content but can be limited to SD quality video instead of HD or 4K quality video. Carriers can likewise select whether to limit video content to specific formats, such as when hardware that processes content is nearing capacity.

In particular, a specific architecture is provided to implement a bandwidth management engine that has bandwidth usage throttling for specific applications. The bandwidth usage throttling for each specific application can be controlled as a function of a number of independent variables, such as an organizational group that an individual device is assigned to, a time of day, a usage threshold or other independent variables. A management interface can be provided to allow management control of these independent variables to be provided, and also to allow management to dynamically created management groups, move devices into and out of management groups, move applications into and out of management groups and to provide other useful functions.

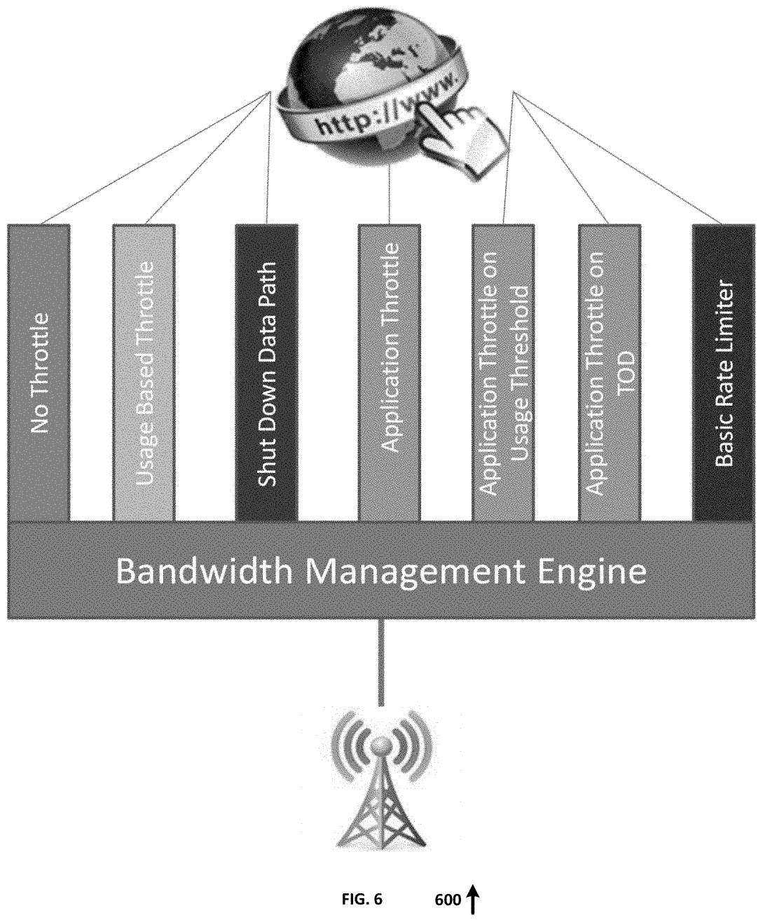

FIG. 6 is a diagram of a system 600 for bandwidth management, in accordance with an example embodiment of the present disclosure. System 600 can be used to provide numerous different configurations, such as a basic data path with no throttling and just usage counting, a usage-based throttle with one or more of a shutdown mode, an application throttling mode, an application throttling mode based on usage limits, and application throttling mode based on based on time of day, a basic rate limiter or other suitable configurations. The basic data path mode can allow user data to be counted but passed at the speed of the limiting factor of the path. The usage-based throttle mode allows a user session to be accumulated, and when a threshold is reached, the user's overall data session is throttled to a chosen speed. The shutdown mode allows an operator to force shut down or closing the data transmission pipeline in response to a limit defined for data usage as a function of a user, subnet or other suitable factor, where the user can be alerted when this occurs, such as through email or text. The application throttling mode allows user data sessions to be set to a specified speed, such as to reduce video data traffic from HD or 4K down to SD. The application throttling off of a usage threshold mode can determine when a usage threshold has been met for a user application, where throttling setup can be enabled for a specified period of time based on the usage threshold time parameter. The application throttling by time of day mode can be configured to enable preset application throttles based on a time of day policy. The basic rate limiter mode can allow a user's data sessions to be configured to a specified data pipeline size.

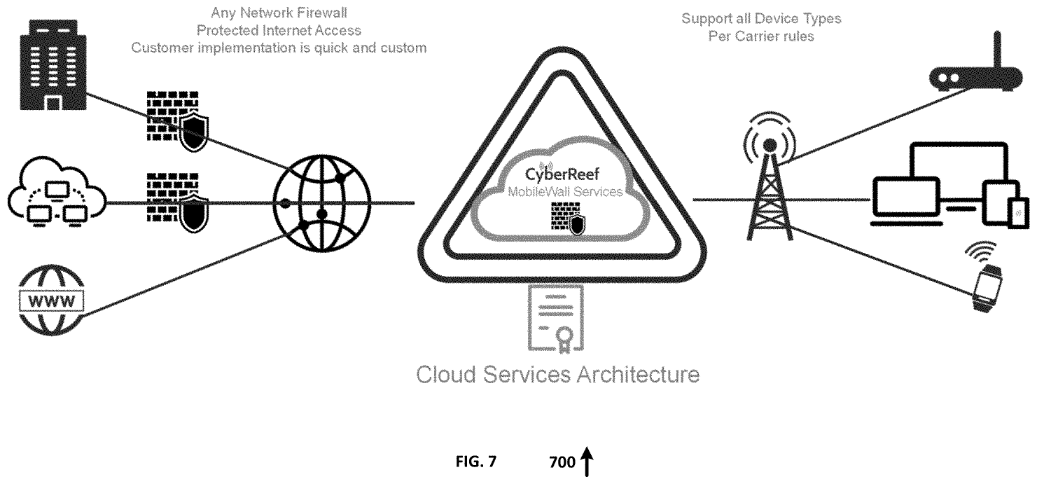

FIG. 7 is a diagram of a system 700 for providing a cloud services architecture, in accordance with an example embodiment of the present disclosure. System 700 can be used to provide a private networking method and associated services in that private network. The private network service can also be applied in carrier networks, and can be controlled by the carrier, the customer or other suitable parties. System 700 is compatible with any network firewall, can provide protected Internet access and allows customer implementation to be quickly provided and customized. System 700 is compatible with all carrier-supported devices.

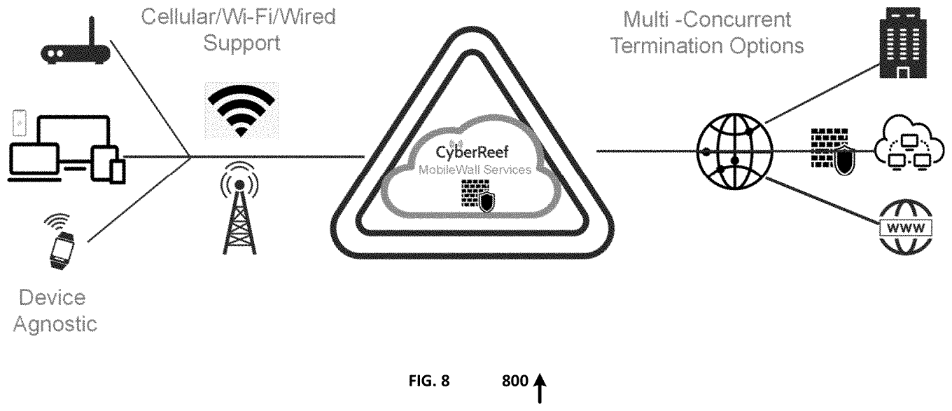

FIG. 8 is a diagram of a system 800 for application throttling, in accordance with an example embodiment of the present disclosure. System 800 provides device agnostic support over cellular, Wi-Fi or wired networks, and can be used with multiple concurrent termination options. System 800 can be used for application throttling, to provide a mobile data management always on zero trust virtual private network, and other suitable functions. Application Throttling can be applied in the 5G architecture at each of the levels defined below with or without a private network, and can work within aggregated private networks, single VPN network connections or other suitable networks.

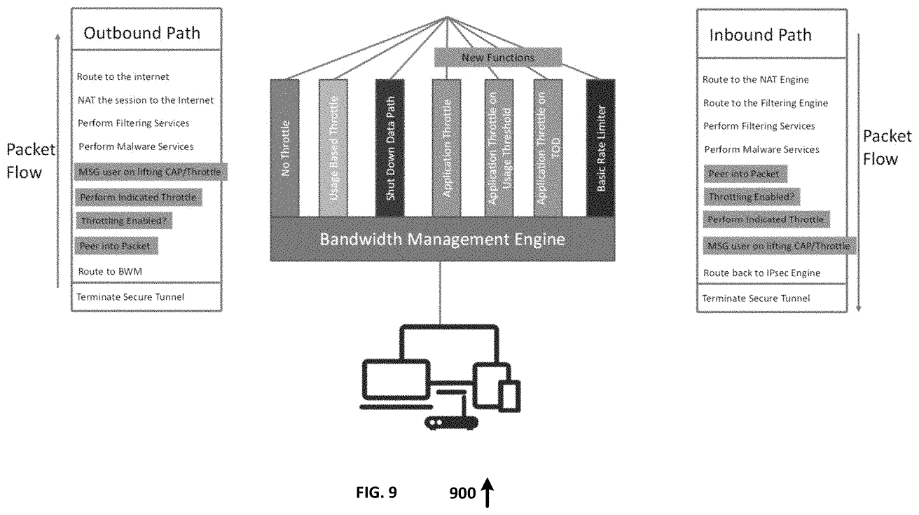

FIG. 9 is a diagram of a system 900 for bandwidth management, in accordance with an example embodiment of the present disclosure. System 900 provides packet flow processing at the outbound path to support Internet routing, network address translation, filtering, malware detection, messaging users to lift or modify data bandwidth caps or throttling, deep packet inspection, bandwidth manager access and other suitable functions. Packet flow processing at the inbound path can be used to support network address translation, filtering, malware detection, messaging users to lift or modify data bandwidth caps or throttling, deep packet inspection, bandwidth manager access and other suitable functions. The bandwidth management engine can be used to provide a determination of throttling or no throttling, a usage based throttle, a data path shutdown, application throttling, application throttling on a usage threshold, application throttling on time of data and other suitable functions as disclosed and discussed herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for processing network data, comprising:
receiving a data packet at a first processor having a non-transient data memory;
storing the data packet in the non-transient data memory;
accessing one or more first data fields of the data packet in the data memory;
determining whether a device is bandwidth limited as a function of the first data fields being associated with an application;
transmitting the data packet to a second processor over a network if it is determined that the device is not bandwidth limited;
determining whether the device has reached a limit if it is determined that the device is bandwidth limited;
transmitting the data packet to the second processor over the network if it is determined that the limit has not been reached; and
deleting the data packet without transmitting the data packet if it is determined that the limit has been reached.

2. The method of claim 1 further comprising accessing one or more second data fields of the data packet in the data memory.

3. The method of claim 2 further comprising determining whether the device is bandwidth limited as a function of the second data fields being associated with a group of applications.

4. The method of claim 2 further comprising determining whether the device is bandwidth limited as a function of the second data fields being associated with a group of users.

5. The method of claim 2 further comprising determining whether the device is bandwidth limited as a function of the second data fields being associated with a time of day.

6. The method of claim 1 further comprising transmitting a notification to a user if it is determined that the limit has been reached.

7. The method of claim 6 further comprising receiving a request from the user to increase the limit.

8. The method of claim 7 further comprising determining whether additional bandwidth is available in response to the request.

9. The method of claim 8 further comprising increasing the limit if it is determined that additional bandwidth is available.

10. A method for processing network data, comprising:
receiving a data packet at a first processor having a non-transient data memory;
storing the data packet in the non-transient data memory;
accessing one or more first data fields of the data packet in the data memory;
determining whether a device is bandwidth limited as a function of the first data fields being associated with an application and a total amount of data that has been used;
transmitting the data packet to a second processor over a network if it is determined that the device is not bandwidth limited;
determining whether the device has reached a data limit if it is determined that the device is bandwidth limited;
transmitting the data packet to the second processor over the network if it is determined that the data limit has not been reached; and
deleting the data packet without transmitting the data packet if it is determined that the data limit has been reached.

11. The method of claim 10 further comprising accessing one or more second data fields of the data packet in the data memory.

12. The method of claim 11 further comprising determining whether the device is bandwidth limited as a function of the second data fields being associated with a group of applications.

13. The method of claim 11 further comprising determining whether the device is bandwidth limited as a function of the second data fields being associated with a group of users.

14. The method of claim 11 further comprising determining whether the device is bandwidth limited as a function of the second data fields being associated with a time of day.

15. The method of claim 10 further comprising transmitting a notification to a user if it is determined that the limit has been reached.

16. A method for processing network data, comprising:
receiving a data packet at a first processor having a non-transient data memory;
storing the data packet in the non-transient data memory;
accessing one or more first data fields of the data packet in the data memory;
determining whether a device is bandwidth limited as a function of the first data fields;
transmitting the data packet to a second processor over a network if it is determined that the device is not bandwidth limited;
determining whether the device has reached a limit if it is determined that the device is bandwidth limited;
transmitting the data packet to the second processor over the network if it is determined that the limit has not been reached; and
deleting the data packet without transmitting the data packet if it is determined that the limit has been reached.

17. The method of claim 16 further comprising accessing one or more second data fields of the data packet in the data memory.

18. The method of claim 17 further comprising determining whether the device is bandwidth limited as a function of the second data fields being associated with a group of applications.

19. The method of claim 18 further comprising determining whether the device is bandwidth limited as a function of the second data fields being associated with a group of users.

20. The method of claim 17 further comprising determining whether the device is bandwidth limited as a function of the second data fields being associated with a time of day.
